(19) United States
(12) Patent Application Publication
(10) Pub. No.: US 2007/0242836 A1
(43) Pub. Date: Oct. 18, 2007

(54) CUSTOMIZABLE EVENT DRIVEN CONTENT PLAYBACK SYSTEM

(75) Inventors: Otman A. Basir, Waterloo (CA); David Erik Klein, Toronto (CA); Jean-Pierre Bhavnani, Kitchener (CA); David Bullock, Waterloo (CA)

Correspondence Address: CARLSON, GASKEY & OLDS, P.C., 400 WEST MAPLE ROAD, SUITE 350, BIRMINGHAM, MI, 48009, US

(73) Assignee: Intelligent Mechatronic Systems Inc., Waterloo (CA)

(21) Appl. No.: 11/619,202

(22) Filed: Jan. 3, 2007

Related U.S. Application Data
(60) Provisional application No. 60/755,328, filed on Dec. 31, 2005.

(51) Int. Cl. B60Q 5/00

(52) U.S. Cl. 381/86

(57) ABSTRACT

This invention describes a system that plays back content based on in-vehicle function triggers. The invention may be used for a variety of applications. In one example, the control unit ties to the remote keyless entry (RKE) system and uses the vehicle signal to the function as playback trigger for the content. In-vehicle subsystems such as warning and information signals or other systems with manual triggers like the RKE system may also be tied to the vehicle unit to trigger content playback. Content delivery scenarios provide secure and robust transmission from an original source to the vehicle unit. The vehicle unit stores the content in an on-board storage. Content loading and operation of the system is configured using a computer or handheld device.

This application claims priority to U.S. Provisional Application Ser. No. 60/755,328 filed Dec. 31, 2005.

### TECHNICAL FIELD

This invention relates to an event-driven content playback system for vehicles, where user-selected media clips are associated with vehicle functions and are played based upon the activation of the associated vehicle functions.

### DESCRIPTION OF THE RELATED ART

Vehicle customization is a hobby for many automobile enthusiasts. Modifications to vehicles such as tinted windows, additional lighting, large-capacity stereos, hydraulic suspensions, decals etc. have all been used as means of enthusiasts to entertain themselves and be unique. Similarly, the proliferation of customized ring tones has exploded amongst cell phone users. This invention combines the two ideas allowing the user to customize and improve the sound the vehicle makes when a given event occurs. This includes replacing the traditional horn sound outside the vehicle when pressing buttons on a key fob to replacing a low gas warning tone on the inside of the vehicle.

Sounding of the vehicle's horn for a remote keyless entry does provide a satisfactory signal so that the operator can verify whether the remote control device has been properly engaged and can also assist a driver to relocate his vehicle when he returns to a large and crowded parking area. However, car horns all sound very similar. If two or more vehicle operators concurrently engage their keyless entry remote control devices it may be difficult to distinguish one vehicle's horn from the other. Similarly, when a driver uses the remote control to lock his vehicle while walking away from it, the signal of a horn sounding cannot necessarily be identified as coming from his own vehicle.

The proposed invention can work with any existing RKE or vehicle security system, or any other event generating system such as the in-vehicle monitoring system that sends warning signals for low gas, low oil pressure etc.

Accordingly, it is desirable to have a customized audible signal that is to verify the activation of a vehicle event.

### SUMMARY OF THE INVENTION

This invention describes a system that plays back content based on user-configurable vehicle triggers. The invention may be used for a variety of applications such as vehicle personalization and customization, vehicle event-acknowledgement, and entertainment. In one embodiment, the control unit ties to the remote keyless entry (RKE) and/or vehicle security system. In-vehicle subsystems such as warning and information signals or other systems with manual triggers may also be tied to the vehicle unit to trigger content playback. The vehicle unit stores the content in a portable storage device. Content loading and operation of the system is configured using a computer.

The invention comprises a vehicle unit, which interfaces to receive the content, store the content, and to receive playback event triggers. Additionally the system includes control circuitry, storage, software and lastly playback hardware if not already provided by the vehicle. The system may include a digital audio source with a signal amplifier and loudspeaker.

The control unit is programmable with recorded sounds that can be transferred from a remote bank of digital sounds, for example by being downloaded from an internet website. The control unit includes connectivity means by which digital sound recording can be transferred to it.

An almost limitless selection of sounds, for example from an Internet website, provides an audio signal for a vehicle event. These audio signals may include unique tones created specifically for the purpose. They may also include brief excerpts of recorded music or dialogue.

The ease of selection of different sound recording also facilitates using the audio signal to provide a source of amusement. For example, the owner of a motor vehicle could regularly change the audio signal for his vehicle's remote control locking mechanism to his current favorite song, or different recorded lines of dialogue. Recorded sounds available on an Internet website could also include voice messages, such as greetings or warnings, or expressions of support for favorite sports teams. The control unit may be configured to play certain signals for different events, at certain times or the day, or on specific dates.

Operation of an Internet website making available a bank of downloadable recorded sounds for such an audio signal system for vehicle remote control locking mechanisms may be undertaken on a commercial basis, with customers making payments for each recorded sound they download. The operator of the internet website could also derive revenue from selling advertising, for example, in connection with promoting recorded music and motion pictures for which sound extracts would be available for downloading.

In order that the invention may be more fully understood, various embodiments thereof will now be described in greater detail, it being understood that such description is by way of example only, and is not limiting.

### BRIEF DESCRIPTION OF THE DRAWINGS

Other advantages of the present invention can be understood by reference to the following detailed description when considered in connection with the accompanying drawings wherein:

FIG. 1 is a schematic of an event-driven playback system according to the present invention;

FIG. 2 illustrates a system and method for distributing media to the event-driven playback system of FIG. 1;

FIG. 3 illustrates one embodiment of a main window of a software application for loading content;

FIG. 4 illustrates one embodiment of an add rule window of a software application for loading content;

FIG. 5 illustrates one embodiment of a modify rule window of a software application for loading content; and

FIG. 6 illustrate one method of converting content into the required playback system format.

### DETAILED DESCRIPTION OF THE PREFERRED EMBODIMENTS

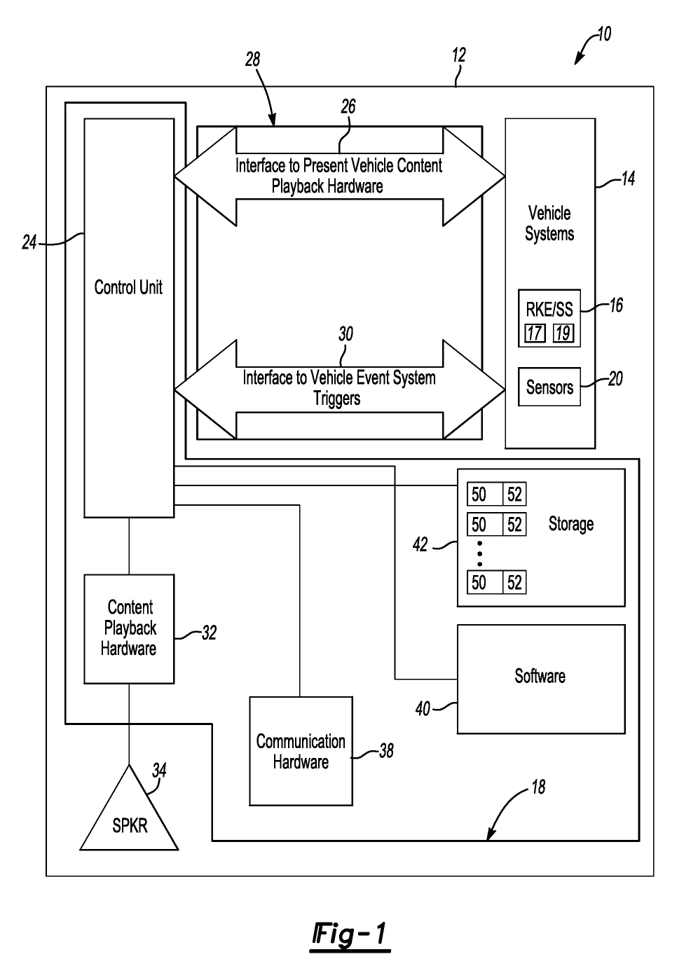

An event-driven content playback system 10 according to the present invention is schematically illustrated in FIG. 1. The playback system 10 is installed in a vehicle 12 having vehicle systems 14, which may include a remote keyless entry (RKE)/vehicle security system 16 and other vehicle sensors 20.

The RKE/vehicle security system 16 may include sensors 17 and actuators 19 for door lock, primary door unlock, all doors unlock, trunk release, panic and remote start, for example. The sensors 20 include any other vehicle sensors whose output may or could generate a warning or indication to a person. The sensors 20 may include low gas warning, low oil pressure warning, low windshield washer fluid warning, seatbelt(s) not connected warning, engine problem warning, brake problem warning, airbag problem warning, anti-lock-brake system problem warning, low battery warning, high temperature warning, door ajar warning, trunk ajar warning, hood ajar warning, etc.

The playback system 10 further includes a control unit 24 with an interface to the vehicle event system triggers 30. The control unit 24 interfaces with the vehicle event system trigger 30 to read the signal sent from the vehicle to the specific vehicle event. For example, the control unit 24 intercepts the signal from the vehicle to the door locks to unlock the doors, whether the signal is originated from the RKE/SS system or from within the car. As a result the control unit 24 utilizes the vehicle signal and does not require a separate signal to initiate the content playback.

The control unit 24 is connected to the vehicle 12 through communication hardware 38, such as wired and wireless communication hardware, for example, RF, BlueTooth, IEEE 802.11, USB port, removable media reader, etc. The communication hardware 38 is preferably a wired connection to reduce possible interference. The communication hardware 38 may include wiring to attach to each vehicle system 14 to intercept the system trigger 30.

The system 10 also includes content playback hardware 32, such as a decoder, amplifier, etc. and a transducer, such as a speaker. The content playback hardware 32 may be arranged such that the user may hear and/or see the content from within the vehicle 12 or from the vehicle 12 exterior, or both. For example, the content playback hardware 32 could include a speaker 34 located within the engine compartment of the vehicle 12 resulting in a user from the exterior of the vehicle 12 being able to hear the content playback. Additionally, the content playback hardware 32 can also include a speaker 34 within the passenger compartment allowing the user within the vehicle 12 to hear the content playback. Depending on the vehicle function 52 triggered, the control unit 24 may send a signal to either or both of the speakers 34. Alternately, the playback system 10 may be connected through an interface 26 to the content playback hardware 32, such as the vehicle speakers or lighting, not requiring separate units.

The system 10 includes two interfitting portions, a cradle 28 and a core 18. The cradle substantially 28 includes the interfaces 26, 30 and may be mounted within the vehicle 12. The cradle 28 is preferably mounted under the dash of the vehicle 12 or in another easily accessible position. The core 18 is removably connected to the cradle 28 and includes the communication hardware 38, the content playback hardware 32, software 40 and storage 42. Alternatively, the content playback hardware 32 could be on the cradle 28. The core 18 is used to transfer content 50 to the vehicle 12 and to playback content 50 in the vehicle 12. The software 40 and storage 42 are used for storing programs, algorithms, and other information needed to operate the playback system 10. The storage 42 may be a hard drive, RAM or other memory or digital storage, storing content 50 and associating them with vehicle functions 52. In the example described here, the content 50 are audio files, such as MP3s, WAV, or other complex sound clips, which may be compressed.

The control unit 24 is configured to play back the stored content 50 in the event of a set of predefined vehicle functions 52. Upon detecting the occurrence of a vehicle function 52, the control unit 24 references the storage 42 to obtain the assigned content 50 for the vehicle function 52. The content 50 plays back through content playback hardware 32. Each vehicle function 52 may be assigned specific content 50 that is pre-selected by the user. For example, different content 50 may be selected for locking the vehicles doors, unlocking the vehicle doors, opening the vehicle trunk, etc.

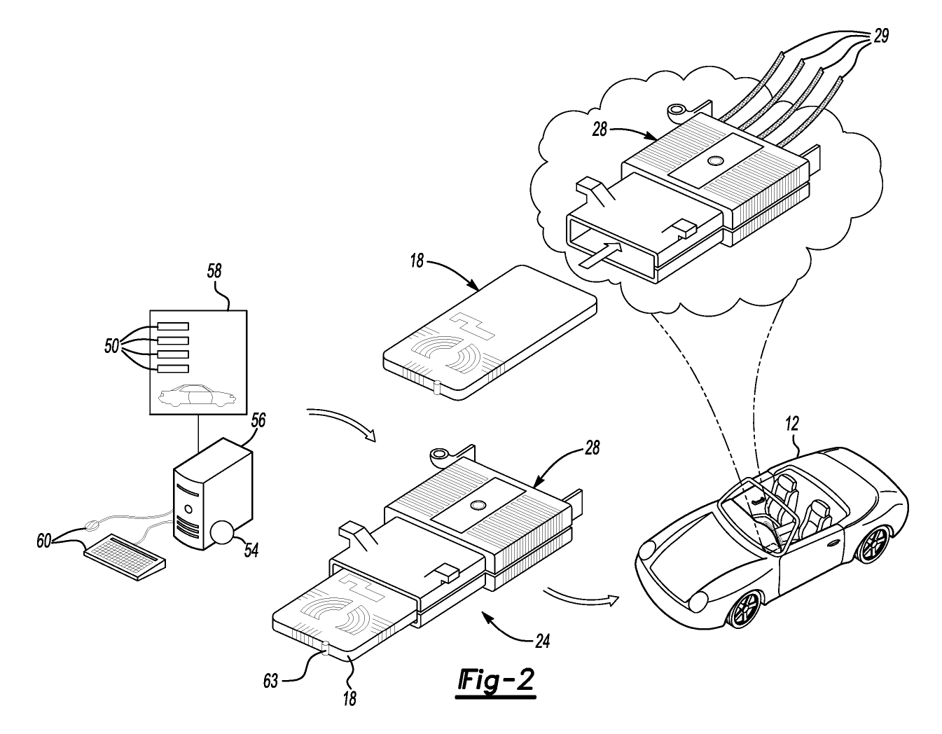

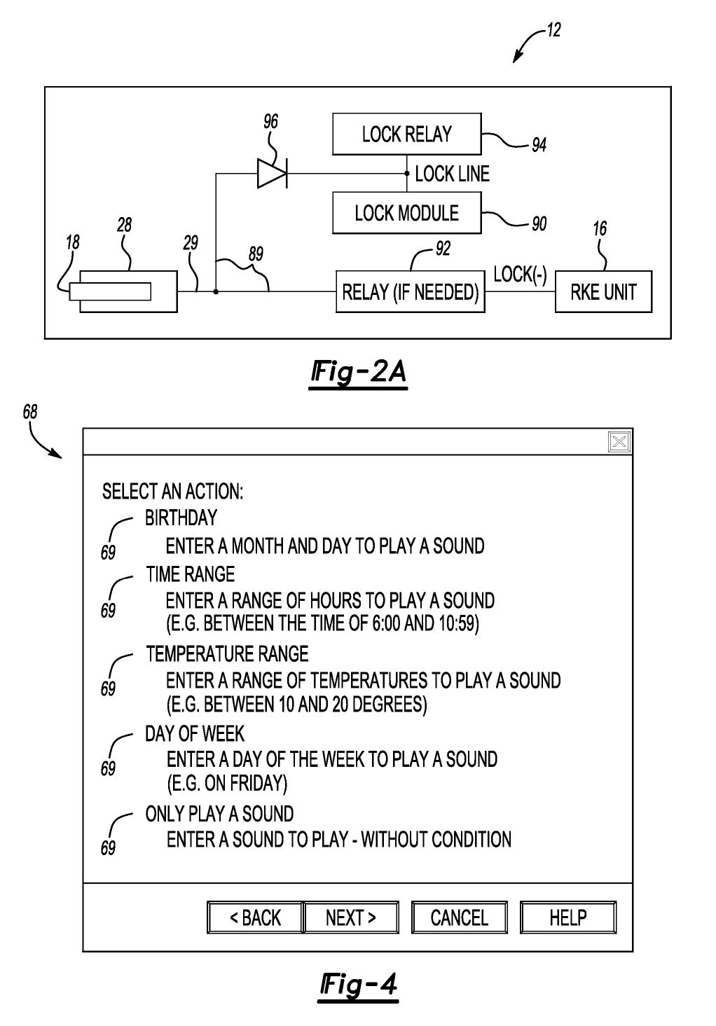

FIG. 2 illustrates one example for distributing the content 50 to the vehicle 12. A provided software application runs on a computer 56. The computer 56 includes a display 58, mouse and keyboard or other input devices 60. The control unit 24 is connected to the computer 56 through the core 18, which may be removed from the vehicle 12. The core 18 includes means for connecting to the computer 56, such as a USB port or wireless connection, such as Bluetooth or wi-fi.

In this embodiment, the system 10 can be configured to automatically initiate a data transfer upon connection of the control unit 24 to the computer 56 or allow the user to press a synchronize button on the control unit 24 to transfer the data. The software application permits a user to select content 50 and assign the content 50 to various vehicle functions 52. The software provides a user-friendly interface to associate content 50 to a vehicle function 52 and an option to preview the content 50 prior to assigning it to a given vehicle function 52. Content 50 may take many forms including but not limited to audio clips, video clips, ring tones, maps, documents etc. and from any source. For example, the user can choose a music clip or a ring-tone to play when he or she triggers the door unlock. Another example, the user can choose a music clip or ring tone to play when he/she triggers the trunk unlock. Each event may be assigned unique content 50 if desired. The software stores the content 50 in the storage 42 (shown in FIG. 1) on the core 18.

The control unit 24 is then disconnected from the computer 56 and connected to the vehicle 12 by inserting the core 18 into a cradle 28 which is mounted in the vehicle 12. The cradle 28 includes a plurality of wires 29 that are connected to various wires in the vehicle to monitor desired vehicle functions. In this case, when an event is detected by the control unit 24 for which content is to be played, the control unit 24 accesses the storage 42 to retrieve and playback the content 50.

As can be seen in FIG. 2, the core 18 includes an override button 63 for selectively temporarily or permanently disabling playback. The override button 63 may occur for a temporary period of time, or pre-determined number of signals sent to the given vehicle function, or permanently until the override button 63 is pressed again. In this manner the user may prevent content playback that may be heard by others at inappropriate times or locations. For example, the user may choose to override the selected content 50, such as a music clip, playing for the door lock or unlock function prior to attending a funeral. In one embodiment, pressing the override button 63 once disables playback for one hour, twice disables playback for 24 hours, three times disables playback until the override button 63 is pressed a fourth time. The override button 63 may be luminous so that it can remain solid (on), flash slowly (one hour delay), quickly (24-hour delay) or off (disabled).

One way of connecting one of the wires 29 to associate it with one or two vehicle functions 52 (depending upon the vehicle 12) is shown in FIG. 2A. The wire 29 is connected to a wire 89 between the RKE unit 16 and the door lock module 90. If a relay 92 is needed, the wire 29 is connected between the relay 92 and the door lock module 90. When the RKE unit 16 activates the lock module 90 to lock, e.g. when the RKE unit 16 connects wire 89 to ground, that vehicle function 52 is detected on wire 29. If the RKE unit 16 uses the same wire 89 to activate lock module 90 to unlock (e.g. by connecting wire 89 to high), then the same wire 29 can be used to detect both the lock and unlock vehicle functions 52. If it is desired that the manual lock relays (manual door lock/unlock switches) 94 do not activate vehicle content 50, then an optional diode 96 can be placed on wire 89 between the wire 29 and the lock module 90 and lock relay 94. This will permit the signal from the RKE unit 16 to activate the lock module 90 and to be detected by the core 18 and cradle 28, but the signal from the lock relay 94 to the lock module 90 will not be detected by the core 18 and cradle 28.

It should be noted that one way of dealing with the prospect of circuits that are normally open and connected to either high or ground when activated is to provide circuitry assigning some (e.g. half) of the wires 29 to treat open circuits as grounded and the rest to treat open circuits as high. When connecting to systems that signal between high and ground, any of the wires 29 can be used.

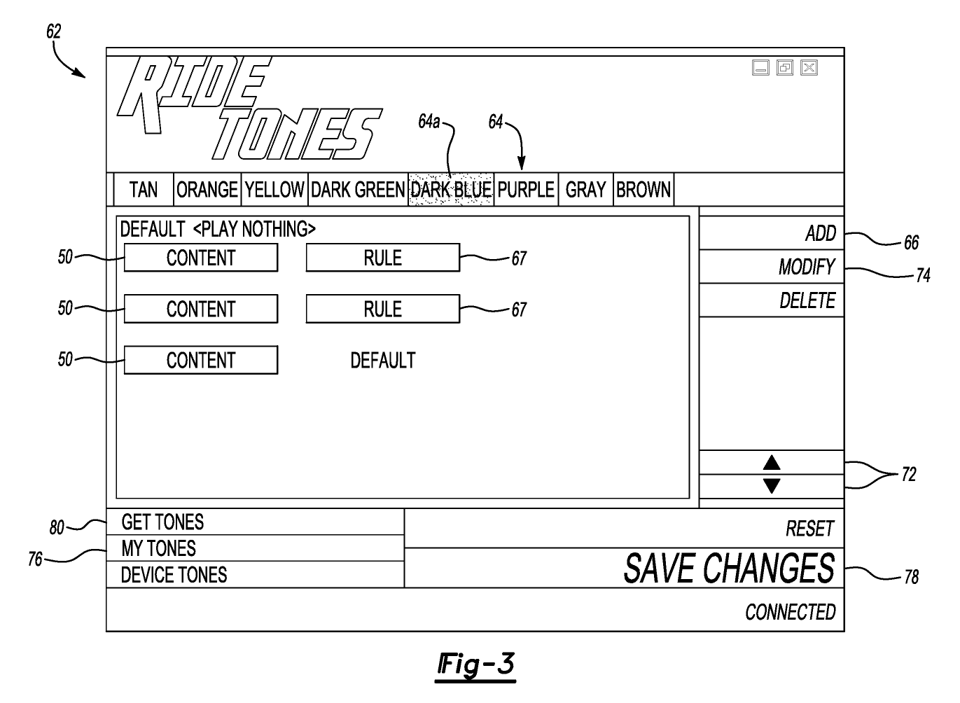

FIG. 3 shows a main window 62 of the software application running on the computer 56 of FIG. 2 for loading content onto the cradle 18. The software includes two tabs 64 associated with each of the wires 29 (FIG. 2), one for monitoring a rising edge on the associated wire 29 and one for monitoring a falling edge on the associated wire 29. Thus, each tab 64 corresponds to a different vehicle function 52 (e.g. door lock, door unlock, etc). The tabs 64 are initially labeled according to the communication hardware identifiers (such as the colors of the wires 29) for simplicity. The user may rename the setting by double-clicking on the tab 64. The user may note which color wires are associated with which vehicle functions 52 and then rename the tab 64 accordingly.

The software also includes an Add button 66 that is used to associate content 50 to a vehicle function 52 (i.e. tab 64). The user selects the desired tab 64 and then selects the add button 66. The software directs the user through a series of windows for selecting an event playback rule and associating content 50 with that rule. For example, the user may select a dark blue tab 64a, which (via choice of wires 29) is associated with the door unlock event. The user then selects the add button 66 to associate rules 67 and content 50 with the door unlock event. Generally, the content 50 will be played based upon the occurrence of the associated function 52 under the associated rule 67.

Upon clicking the add button 66, a rule window 68 appears, as shown in FIG. 4. The user selects the desired rule for playing content, e.g. play the content 50 every Friday. FIG. 4 displays a list of categories 69 of rules 67: birthday (month and day), time range, temperature range, day of week, and only play a sound (without rules). Subsequent screens (not shown) would allow the user to program specific rules 67 within the selected category 69.

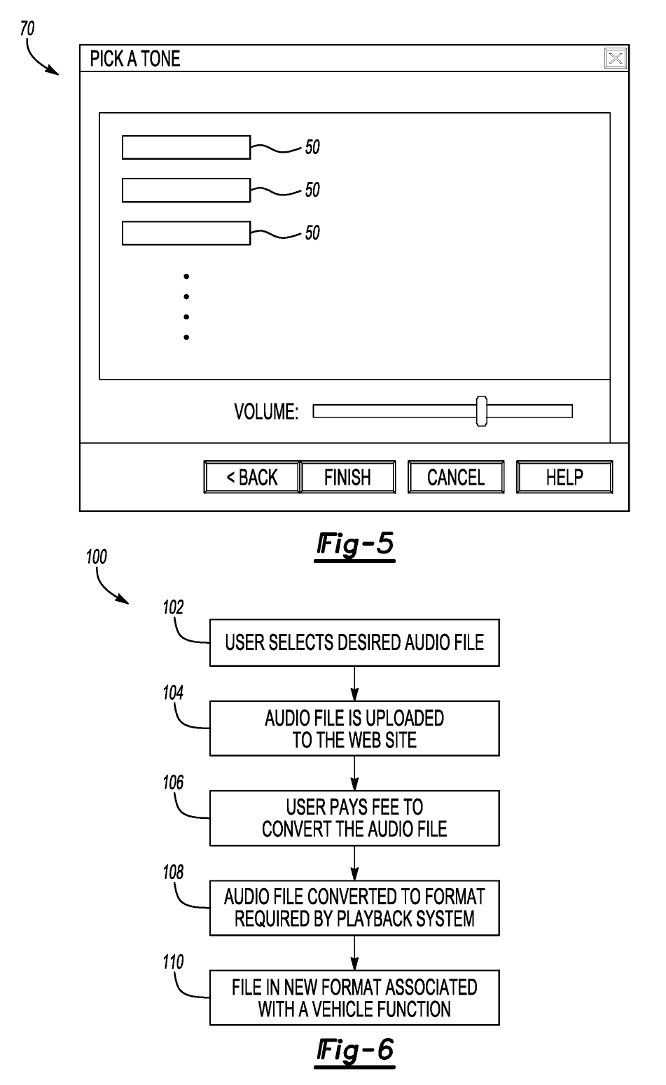

Once a rule is selected the content window 70 appears, as shown in FIG. 5. The user selects the desired content 50 to be played upon the occurrence of the vehicle function 52 (FIG. 3) and the rule 67 selected in FIG. 4. The selected rule 67 and content 50 would then be displayed in the main window 62 shown in FIG. 3. As shown, more than one content 50, each with a different rule 67, can be associated with each tab 64 (i.e. vehicle function 52).

Each tab 64 displays a list of the rules and content selected for that vehicle function 52. The content 50 is prioritized by the order of the list. Thus, by moving a rule and content up the list it is given higher priority. Any conflicts among rules (e.g. when more than one rule is satisfied upon the occurrence of the associated vehicle function 52) are resolved based upon the order listed, with higher content 50 taking priority. Priority buttons 72 can be used to move a rule and content 50 up or down the list. As can be understood, multiple rules and content can be selected for each vehicle function 52. A default setting (if no rules 67 are satisfied) of not playing any content is typically assigned to each setting. Alternatively, one content 52 may be assigned as default, as shown, so that it is played if none of the rules 67 are satisfied. The default setting is given lowest priority as rules 67 and content 50 are added.

The modify button 74 can be used to modify the content 50 associated with a specific rule. Using the example of above, if the Friday rule is chosen and the user selects the modify button the software would open the content window 70 so a new content 50 may be chosen.

The user may listen to the available content by double-clicking on a song while the content window is open, or by selecting the My Tones button 76 and selecting the desired content to be played.

If the desired content 50 is not available the user may obtain more by selecting the Get Tones button 80, which takes the user to a website where content 50 can be purchased. The content 50 is preferably encoded so that it only plays on the authorized core 18 and the core 18 is programmed to only play properly encoded content 50.

Referring to FIG. 6, one method 100 in which the user may obtain content 50 is to convert content available in one format to the encoded format appropriate for the system 10. The user may for use a website providing the appropriate conversion software or may purchase and load the appropriate conversion software onto the computer 56. In the first step 102 the user selects the desired content (on their own computer 56, FIG. 2) to convert. The user then uploads 104 the content 50 to the website or computer conversion software. Upon paying a fee 106, the website conversion software converts 108 the content 50 to the appropriate encoded format for the system 10. The user then downloads the converted content 50 and then associates 110 the content 50 with the desired vehicle function 5 as explained above.

Once the user has completed assigning the desired content 50 to the vehicle function 52 the Save Changes button 78 is selected to save the changes to the core 18. The content 50 is assigned to vehicle functions 52 in the manner described above. The core 18 is then connected to the vehicle 12 by fitting within the cradle 28.

Although a preferred embodiment of this invention has been disclosed, a worker of ordinary skill in this art would recognize that certain modifications would come within the scope of this invention. For that reason, the following claims should be studied to determine the true scope of legal coverage available for this invention.

We claim:

1. A customizable audio system for a vehicle, comprising:
a control unit configured to receive a first signal and to transmit a second signal based on said first signal, said second signal adapted to initiate a vehicle function;
a storage unit having at least one audio file associated with said vehicle function; and
a content playback hardware configured to play said at least one audio file based on a transmission of said second signal.

2. The system of claim 1, wherein said first signal comprises a wireless signal initiated by a user.

3. The system of claim 2, wherein a remote keyless entry device transmits said first signal.

4. The system of claim 1, further including a user interface for associating said at least one audio file.

5. The system of claim 4, wherein said user interface comprises a computer.

6. The system of claim 5, wherein said storage is detachable from said vehicle and connectable to said computer.

7. The system of claim 5, wherein said storage is moveable between a first location docked with said vehicle and a second location docked with said computer.

8. The system of claim 1, wherein said content playback hardware comprises at least one vehicle speaker.

9. A customizable audio system for a vehicle, comprising:
a control unit configured to generate a second signal based on receipt of a first signal;
an actuator for initiating a vehicle function in response to said second signal;
a storage unit for storing at least one audio file; and
a content playback hardware adapted to play said at least one audio file, wherein said control unit initiates play of said at least one audio file in response to said second signal.

10. The system of claim 9, including an override for generating a standard response in place of said at least one audio file.

11. The system of claim 10, wherein said override extends for a set duration of time.

12. The system of claim 10, wherein said override expires after a set number of said first signals, a set number of said second signals, or a set number of said first signals and said second signals.

13. The system of claim 9, wherein said second signal communicates from said control unit through a wired connection.

14. The system of claim 9, wherein said at least one audio file is associated with said vehicle function.

15. The system of claim 9, wherein said vehicle function comprises actuating at least one of a door lock, a primary door unlock, an all door unlock, a trunk release, or a panic and remote start.

16. The system of claim 9, wherein actuating the vehicle function initiates play of said at least one audio file.

17. A device for customizing an audio system for a vehicle, comprising:
storage for storing at least one audio file;
an interface for associating each at least one audio file with a vehicle function;
a control unit for initiating said vehicle function; and
a content playback hardware adapted to play said at least one audio file in response to initiating said vehicle functions.

18. The system of claim 17, wherein said user interface comprises a computer.

19. The system of claim 18, wherein said storage is detachable from said vehicle and connectable to said computer.

20. The system of claim 18, wherein said storage is moveable between a first location docked with said vehicle and a second location docked with said computer.

21. The system of claim 17, wherein said content playback hardware comprises at least one vehicle speaker.

22. An override for a customizable audio system, comprising:
an actuator for initiating a vehicle function;
a storage unit for storing at least one audio file;
a content playback hardware adapted to play said at least one audio file in response to initiating said vehicle function; and
an override for generating a standard response in place of said at least one audio file.

23. The system of claim 22, wherein said override extends for a set duration of time.

24. The system of claim 23, wherein said override comprises a button.

25. The system of claim 24, wherein actuating said button controls said set duration of time.

26. A method for playing an audio file including the steps of:
associating an audio file with a vehicle function; and
playing the audio file in response to a signal from the vehicle, the signal initiating the vehicle function.

27. The method of claim 26, including uploading an audio file to a website and associating the audio file using an interface on the website.

28. The method of claim 26, including converting the audio file to a format playable from a vehicle utilizing software.

29. The method of claim 28, including accessing a fee based website for converting the audio file.

30. The method of claim 26, including obtaining the audio file from a website.
